(19) United States
(12) Patent Application Publication
(10) Pub. No.: US 2008/0018473 A1
(43) Pub. Date: Jan. 24, 2008

(54) ELECTROSTATIC DISCHARGE PROTECTION FOR COMPONENTS OF AN RFID TAG

(75) Inventors: Ching-Long Tsai, Austin, TX (US); Johannes Petrus Maria Kusters, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/458,284

(22) Filed: Jul. 18, 2006

(51) Int. Cl. G08B 13/14

(52) U.S. Cl. 340/572.7; 340/572.8

(57) ABSTRACT

Techniques are described for protecting components of an RFID tag from electrostatic discharge. For example, an RFID tag includes a conductive cage that shields the components of the RFID tag from electrostatic discharge. The conductive cage includes a first conductive shield on a first side of a substrate of the RFID tag and a second conductive shield on a second side of the substrate. The first conductive shield is positioned on the first side of the substrate to cover an integrated circuit (IC). The second conductive shield is positioned on the second side of the substrate, and is substantially opposite from the first conductive shield. The first and second conductive shields are interconnected by one or more conductors. In this manner, the interconnected conductive shields form a conductive cage that protects the IC from electrostatic discharge.

### TECHNICAL FIELD

The invention relates to radio frequency identification (RFID) systems for article management and, more specifically, to RFID tags.

### BACKGROUND

Radio frequency identification (RFID) technology has become widely used in virtually every industry, including transportation, manufacturing, waste management, postal tracking, airline baggage reconciliation, and highway toll management. A typical RFID system includes a plurality of RFID tags, at least one RFID reader or detection system having an antenna for communication with the RFID tags, and a computing device to control the RFID reader. The RFID reader includes a transmitter that may provide energy or information to the tags, and a receiver to receive identity and other information from the tags. The computing device processes the information obtained by the RFID reader.

A conventional RFID tag typically includes an integrated circuit (IC) and an antenna communicatively coupled to the IC. The tag may further include a number of discrete components, such as one or more capacitors. A conventional tag may be either an “active” tag that includes an internal power source, such as a battery, or a “passive” tag that is energized by the field created by the RFID reader antenna. Once energized, the tags communicate using a pre-defined protocol, allowing the RFID reader to receive information from one or more tags.

RFID tags are susceptible to damage due to electrostatic discharge. Electrostatic discharge may occur during manufacturing, testing, shipping or handling of the tags. For example, electrostatic charge of significant levels may build up while wrapping a crate of tags for shipping. The electrostatic discharge may damage the RFID tag, resulting in reduced read ranges, information corruption or erasure or other types of tag malfunctions.

### SUMMARY

In general, this disclosure describes techniques for protecting components of a radio frequency identification (RFID) tag from damage due to electrostatic discharge. For example, an RFID tag is described that includes a conductive cage that shields the components of the RFID tag from electrostatic discharge. Protecting the components of the RFID tag from electrostatic discharge reduces the chances of the tag becoming damaged during manufacture, testing, shipping or handling of the tag.

As one example, the conductive cage may include a first conductive shield on a first side of a substrate of the RFID tag and a second conductive shield on a second side of the substrate. The first conductive shield may be positioned on the first side of the substrate to cover an integrated circuit (IC). The second conductive shield may be positioned on the second side of the substrate, substantially opposite from the first conductive shield. The first and second conductive shields are interconnected by one or more conductors. In this manner, the interconnected conductive shields form a conductive cage that protects the IC from electrostatic discharge by preventing an electrical field gradient from being applied across the IC.

The conductive cage may be positioned to protect other electrical components of the RFID tag that may be susceptible to damage from electrostatic discharge. The first and second conductive shields may, for example, be positioned to cover capacitive elements as well as the IC. As another example, the first and second conductive shields may be positioned to protect a battery or other power source that may be located on an active RFID tag.

The conductive cage may also be positioned such that it does not cover a substantial portion of an antenna of the RFID tag so as not to adversely affect RF communications. For example, the conductive shields that form the conductive cage may be positioned such that they only shield the IC and any connecting lines or pads used to couple the IC to the antenna, and shield none or a minimal portion of the antenna. This allows the conductive cage to be introduced into the RFID tag with minimal interference with the RF communications and without impacting the capacitance or inductance of the RFID tag and shifting the resonant frequency of the tag.

In one embodiment, a radio frequency identification (RFID) tag comprises a substrate and an antenna formed on a first side of the substrate. The RFID tag also comprises an integrated circuit (IC) communicatively coupled to the antenna. The RFID tag includes a first conductive shield positioned on a first side of the substrate to cover a top portion of the IC, a second conductive shield positioned on a second side of the substrate, and at least one conductor to electrically connect the first conductive shield and the second conductive shield through the substrate.

In another embodiment, a method of manufacturing a RFID tag comprises forming an antenna on a first side of a substrate and communicatively coupling an integrated circuit (IC) to the antenna. The method also includes positioning a first conductive shield on a first side of the substrate to cover a top portion of the IC, positioning a second conductive shield on a second side of the substrate, and electrically coupling the first and second conductive shields through the substrate.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a schematic diagram illustrating a plan view of an exemplary RFID tag that includes a conductive cage to shield components from electrostatic discharge.

FIG. 1B is a schematic diagram illustrating a cross-sectional view of the RFID tag of FIG. 1A.

FIG. 2A is a schematic diagram illustrating a plan view of another exemplary RFID tag that includes a conductive cage to shield components from electrostatic discharge.

FIG. 2B is a schematic diagram illustrating a cross-sectional view of the RFID tag of FIG. 2A.

FIG. 3 is a schematic diagram illustrating a cross-sectional view of a further exemplary RFID tag that shields components of the RFID tag from electrostatic discharge.

FIG. 4 is a schematic diagram illustrating a cross-sectional view of yet another exemplary RFID tag that shields components of the RFID tag from electrostatic discharge.

FIG. 5 is a flow diagram illustrating an exemplary method of forming an RFID tag with a conductive cage.

FIG. 6 is a flow diagram illustrating another exemplary method of forming an RFID tag that shields components of the RFID tag from electrostatic discharge.

FIG. 7 is a graph illustrating exemplary results obtained after subjecting conventional RFID tags and conductive cage RFID tags to electrostatic discharges of varying voltages.

FIG. 8 is a graph illustrating exemplary results obtained after subjecting a conventional RFID tag and a conductive cage RFID tag to several consecutive electrostatic discharges.

### DETAILED DESCRIPTION

In general, this disclosure describes techniques for protecting components of a radio frequency identification (RFID) tag from electrostatic discharge. For example, an RFID tag is described that includes a conductive cage that shields the components of the RFID tag from electrostatic discharge. Protecting the components of the RFID tag from electrostatic discharge reduces the chances of the tag becoming damaged during manufacture, testing, shipping or handling of the tag.

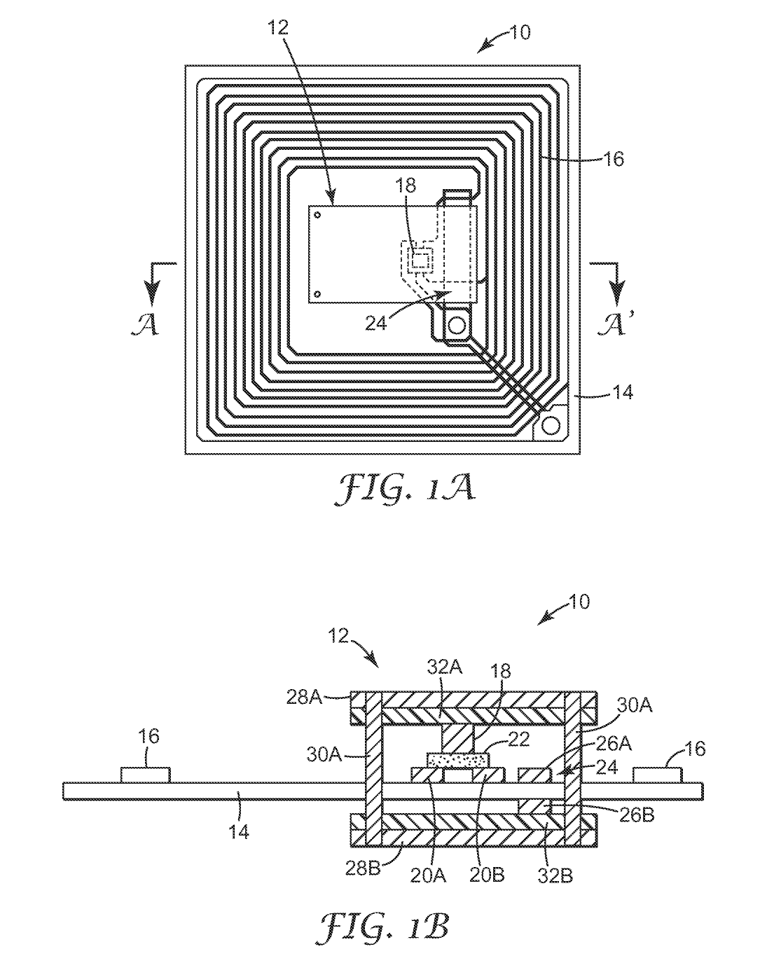

FIGS. 1A and 1B are schematic diagrams illustrating an exemplary RFID tag 10 that includes a conductive cage 12 to shield components of the RFID tag from electrostatic discharge. FIG. 1A illustrates a plan view of RFID tag 10 and FIG. 1B illustrates a cross-sectional view of RFID tag 10 of FIG. 1A from A to A′. In the example of FIGS. 1A and 1B, RFID tag 10 comprises a 13.56 MHz RFID tag. RFID tag 10 may, however, be any RFID tag that includes a capacitive element employed as part of the resonant circuit of the tag, such as a 125 or 134 KHz RFID tag.

As shown in FIG. 1B, RFID tag 10 includes a substrate 14. Substrate 14 may be formed from a polymeric material, such as polyethylene. RFID tag 10 includes an antenna 16 formed on a first side of substrate 10. Antenna 16 receives from and transmits signals to an RFID reader (not shown) via RF communications. Antenna 16 may be formed by depositing or etching a conductive element on substrate 14. The conductive element deposited on substrate 14 to form antenna 16 may, for example, be aluminum, silver, copper or the like. Although antenna 16 illustrated in FIGS. 1A and 1B is a coil antenna, antenna 16 may be realized as various other conductive patterns formed on substrate 14.

RFID tag 10 also includes an integrated circuit (IC) 18 coupled to antenna 16. In the exemplary embodiment illustrated in FIGS. 1A and 1B, IC 18 is coupled to antenna 16 at contact points 20A and 20B. In one embodiment, contact points 20A and 20B are end portions of electrical traces of antenna 16. IC 18 is adhered to contact points 20A and 20B using a conductive adhesive 22, as illustrated in FIG. 1B. In other embodiments, IC 18 may be coupled to IC 18 via contact lines.

In general, IC 18 is programmed with a unique identification number, and may additionally store information associated with a particular item or article to which RFID tag 10 is affixed. For example, IC 18 typically includes memory storing identification information associated with the item, a location associated with the item, a date of manufacture of an item, a destination of an item, a type or class of goods associated with the item, or any other information associated with the item to which RFID tag 10 is affixed. In the example illustrated in FIGS. 1A and 1B, IC 18 and antenna 16 are illustrated as residing on the same side of substrate 14. IC 18 and antenna 16 may, however, reside on opposite sides of substrate 14. In this case, contact points 20A and 20B electrically couple to antenna 16 by vias that extends through substrate 14. In addition, IC 18 may be recessed into a portion of substrate 14.

RFID tag 10 also includes a capacitive element 24 formed on substrate 14. Capacitive element 24 may be formed by depositing or etching conductive elements on opposite sides of substrate 14 or may comprise one or more discrete capacitive elements positioned on the substrate. As illustrated in FIG. 1B, capacitive element 24 may comprise a first capacitive plate 26A formed on a first side of substrate 14 and a second capacitive plate 26B formed on a second side of substrate 14. The conductive element deposited on substrate 14 to form capacitive plates 26A and 26B may, for example, be aluminum, silver, copper or the like.

IC 18 and capacitive element 24 may be susceptible to damage from electrostatic discharge. Electrostatic discharge may, for example, damage IC 18 or capacitive element 24 in a manner that reduces read ranges by changing the resonant frequency of RFID tag 10, corrupts or erases information stored on RFID tag 10 or causes other types of malfunctions to RFID tag 10. To reduce the likelihood of damage from electrostatic discharge, RFID tag 10 includes conductive cage 12 to shield IC 18 and capacitive element 24 from electrostatic discharge.

Conductive cage 12 includes a first conductive shield 28A positioned on a first side of substrate 14 and a second conductive shield 28B positioned on a second side of substrate 14. First conductive shield 28A is positioned on the first side of substrate 14 to cover IC 18 and capacitive element 24. Second conductive shield 28B is positioned on the second side of substrate 14, and is substantially opposite from first conductive shield 28B. Second conductive shield 28B is positioned to cover capacitive plate 26B of capacitive element 24. In this manner, conductive shields 28 are positioned to form a conductive cage 12 that protects IC 18 and capacitive element 24 from electrostatic discharge by preventing an electrical field gradient from being applied across IC 18 and capacitive element 24 during an electrostatic discharge event. First and second conductive shields 28 may be formed from metals, conductive polymers, ceramics, or other substantially conductive material. First and second conductive shields 28 may comprise, for example, pre-formed pieces of copper, silver, aluminum or other conductor that are positioned on RFID tag 10. Alternatively, first and second conductive shields 28 may be formed using conventional deposition or etching techniques.

In the example illustrated in FIG 1B, first conductive shield 28A and second conductive shield 28B are electrically connected by conductors 30A and 30B (“conductors 30”). One or more vias (not shown) may be formed through substrate 14 to allow conductors 30 to pass through substrate 14 and electrically connect first conductive shield 28A and second conductive shield 28B. Conductors 30 may comprise, for example, posts formed from copper, silver, aluminum or the like. Although conductive shields 28 of conductive cage 12 are connected using two conductors, any number of conductors may interconnect conductive shields 28.

RFID tag 10 further includes insulation layers 32A and 32B (“insulation layers 32”) that prevent IC 18 and capacitive element 24 from electrically coupling to conductive cage 12. Insulation layer 32A provides an insulation barrier between first conductive shield 28A and IC 18. Insulation layer 32A may also provide an insulation barrier between first conductive shield 28A and capacitor plate 26A of capacitive element 24. Insulation layer 32B provides an insulation barrier between second conductive shield 28B and capacitive plate 26B of capacitive element 24. Insulation layers 32 may comprise a polymeric material, such as polyimide. Insulation layers 32 may vary in thickness, but to maintain a low profile tag, insulation layers may be approximately 0.5-1 mil thick.

Although conductive cage 12 is only described as being positioned to cover IC 18 and capacitive element 24 from electrostatic discharge, conductive cage 12 may be positioned to shield other components of RFID tag 10. In the case that RFID tag 10 is an active tag, for example, conductive cage 12 may be positioned to cover a power source, such as a battery, of the RFID tag. Thus, conductive cage 12 may be designed and positioned to shield any component of RFID tag 10 that is susceptible to damage due to electrostatic discharge.

Conductive cage 12 may also be positioned and sized so as to cover none or a minimal portion of antenna 16. In other words, first and second conductive shields 28 may be sized and positioned to shield IC 18 and capacitive element 24 without shielding antenna 16. For example, conductive cage 12 may be sized and positioned to cover ending portions of traces of antenna 16 or contact lines that connect to IC 18 via contact points 20. Moreover, conductive cage 12 does not physically contact any portion of antenna 16. This allows conductive cage 12 to be introduced into RFID tag 10 with minimal interference with RF communication and no adverse affect on the capacitance or inductance of RFID tag 10, which may alter the resonant frequency of the tag.

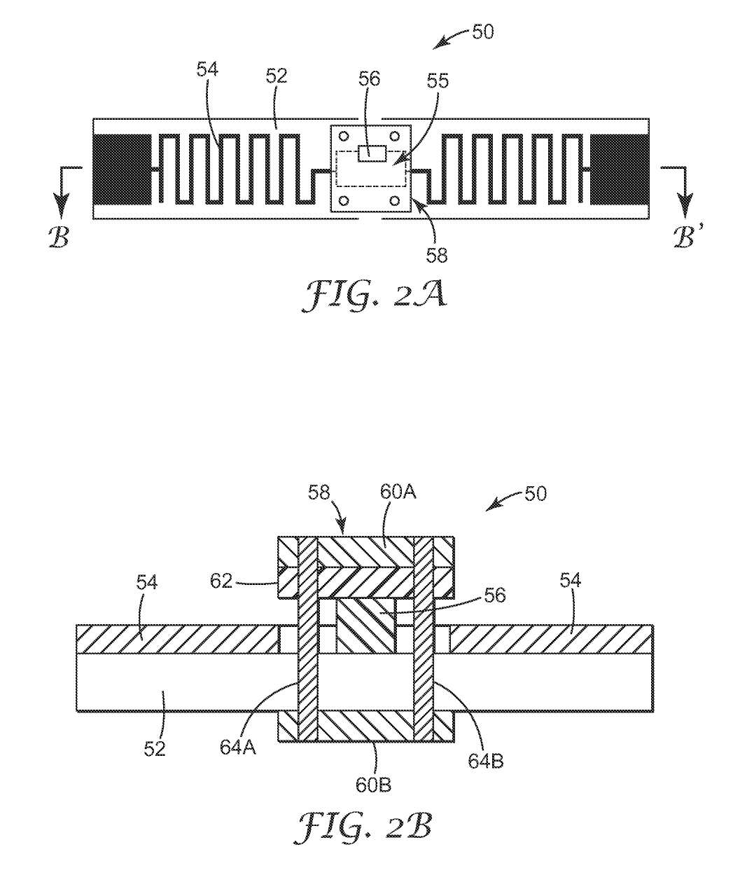

FIGS. 2A and 2B are schematic diagrams illustrating another exemplary RFID tag 50 having a conductive cage that shields components of the RFID tag from electrostatic discharge. FIG. 2A illustrates a plan view of RFID tag 50 and FIG. 2B illustrates a cross-sectional view of RFID tag 50 from B to B′. RFID tag 50 may comprise, for example, an 860-960 MHz RFID tag, a 2.45 GHz RFID tag or any other high frequency or ultra-high frequency RFID tag.

RFID tag 50 includes a substrate 52. Substrate 52 may be formed from a polymeric material, such as polyethylene. RFID tag 50 includes an antenna 54 formed on a first side of substrate 10. Antenna 54 receives from and transmits signals to an RFID reader (not shown). Antenna 54 may be formed by depositing or etching conductive element onto substrate 14 in the pattern illustrated in FIG. 2A. In the example illustrated in FIG. 2A, antenna 54 comprises a quarter-wavelength antenna. Alternatively, other conductive patterns may be used to form antenna 54. The conductive element deposited on substrate 52 to form antenna 54 may, for example, be aluminum, silver, copper or the like.

RFID tag 50 also includes an integrated circuit (IC) 56 coupled to antenna 54. As described above, IC 56 is typically configured with a unique identifier, and may be programmed to store information associated with a particular item to which RFID tag 50 is affixed.

In the example of FIG. 2A, antenna 54 is formed to reduce the effects of electrostatic discharge on IC 56. Specifically, a center portion of antenna 54 forms a loop 55 that reduces the adverse effect of electrostatic discharge. Loop 55 formed at the central portion of antenna 54, however, only provides limited protection from electrostatic discharge. Electrostatic discharges of higher voltage levels would still cause damage to IC 56. Moreover, other types of high or ultra-high frequency tags may not include such a loop in antenna 54 to protect from lower voltage level electrostatic discharge. Thus, RFID tag 50 further includes conductive cage 58 to shield IC 56 from electrostatic discharge.

Conductive cage 58 includes a first conductive shield 60A and a second conductive shield 60B that are electrically connected by at least one conductor. First conductive shield 60A is positioned on the first side of substrate 52 to cover IC 56. Second conductive shield 60B is positioned on a second side of substrate 52, and is substantially opposite from first conductive shield 60B. First conductive shield 60A and second conductive shield 60B may be positioned to shield loop 55 of antenna 54 as well as IC 56. Moreover, first conductive shield 60A and second conductive shield 60B may shield other susceptible components of RFID tag 50. The interconnected conductive shields 60 prevent an electrical field gradient from being applied across IC 56 in an electrostatic discharge event, thus forming a conductive cage 58 that protects IC 56 from electrostatic discharge.

RFID tag 50 further includes insulation layer 62 that prevents IC 56 from electrically coupling to conductive cage 58. In other words, insulation layer 62 provides an insulation barrier between first conductive shield 60A and IC 56. Insulation layer 62 may comprise a polymeric material, such as polyimide.

As illustrated in FIGS. 2A and 2B, first conductive shield 60A and second conductive shield 60B are electrically connected by conductors 64A and 64B (“conductors 64”). One or more vias (not shown) may be formed through substrate 52 and insulation layer 62 to allow conductors 64 to pass through substrate 52 and insulation layer 62, and electrically connect first conductive shield 60A and second conductive shield 60B. Conductors 64 may comprise, for example, posts formed from copper, silver, aluminum or any other conductive material. Although conductive shields 60A and 60B of conductive cage 58 are connected using two conductors, any number of conductors may interconnect conductive shields 60A and 60B.

As with the embodiments of FIGS. 1A and 1B, conductive cage 58 may be positioned to cover none or a minimal portion of antenna 54, i.e., only contact pads or connecting lines. In this manner, first and second conductive shields 60 shield IC 56 without substantially shielding antenna 16. As illustrated in FIGS. 2A and 2B, in one embodiment, conductive cage 58 may cover all or a portion of loop 55 of antenna 54. Thus, conductive cage 58 can be introduced into RFID tag 50 with minimal affect on the capacitance or inductance of RFID tag 50 and, thus little affect on the resonant frequency.

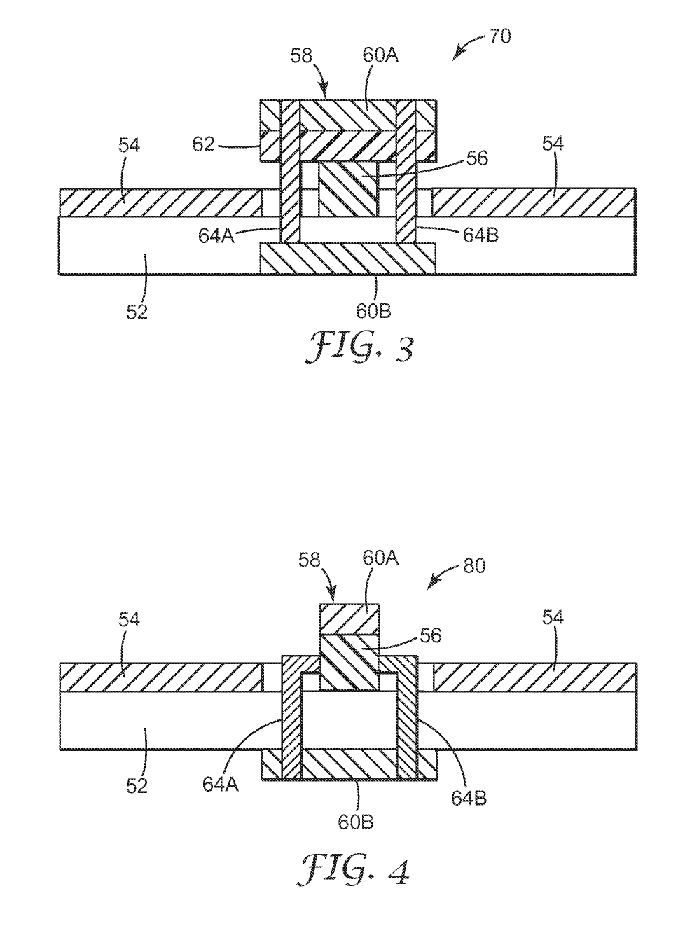

FIG. 3 is a schematic diagram illustrating a cross-sectional view of a further exemplary RFID tag 70 that shields components of the RFID tag from electrostatic discharge. RFID tag 70 conforms substantially to RFID tag 50 of FIGS. 2A and 2B, but second conductive shield 60B of RFID tag 70 is integrated within a bottom portion of substrate 52 as one embodiment as, for example, a conductive film or layer.

FIG. 4 is a schematic diagram illustrating a cross-sectional view of yet another exemplary RFID tag 80 that shields components of the RFID tag from electrostatic discharge. RFID tag 80 conforms substantially with RFID tag 50 of FIGS. 2A and 2B, but first conductive shield 60A of RFID tag 80 is integrated within IC 56 instead of a separate component positioned on top of IC 56. Although not illustrated in FIG. 4, there may be an insulation layer separating conductive shield 60A from the rest of IC 56 in order to ensure that there is no interference from coupling. As a result, the size of the conductive cage formed by the conductive shields may be reduced. In this embodiment, only IC 56 and the portion of loop 55 aligned between IC 56 and second conductive shield 60B are shielded by conductive cage 58.

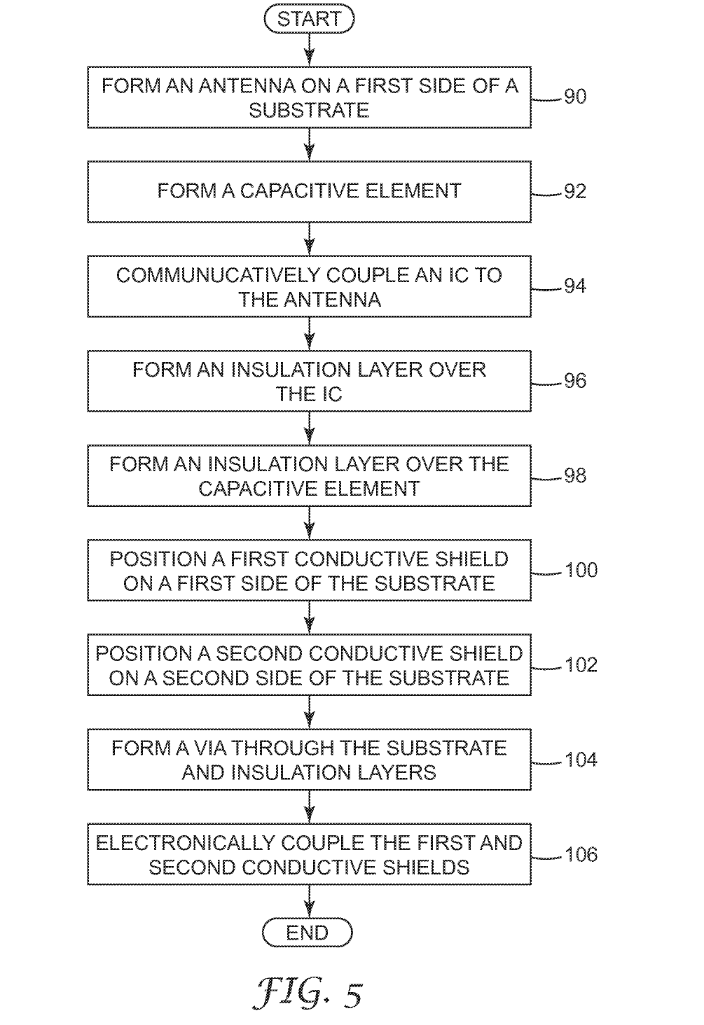

FIG. 5 is a flow diagram illustrating an exemplary method of forming an RFID tag, and is described in reference to RFID tag 10 of FIGS. 1A and 1B. Initially, antenna 16 is formed on a first side of substrate 14 (90). As described above, antenna 16 may be formed on substrate 14 by depositing or etching a conductive element or by forming a densified metal composition in a particular pattern, such as a coil. The conductive pattern may be formed via any number of deposition or etching techniques, such as vapor deposition, chemical etching and the like, or by densification of a metal powder applied with or without an adhesive.

Capacitive element 24 is also formed or placed on substrate 14 (92). As described above, capacitive element 24 may be formed by depositing or etching a capacitive plate on each side of substrate 14. Capacitive element may also be formed by any of a number of deposition or densification techniques. In one embodiment, antenna 16 and one of the capacitive plates 26 of capacitive element 24 may be deposited on the first side of substrate 14 at the same time.

IC 18 is mounted on the RFID tag and electrically connected to antenna 16 (94). IC 18 may, for example, be adhered to contact points 20 that are electrically coupled to antenna 16. In fact, contact points 20 may themselves be a portion of antenna 16 or may terminate connecting lines that connect to antenna 16. IC 18 and antenna 16 may be formed on the same side of substrate 14 or on opposite sides of substrate 14.

Insulation layer 32A is formed over IC 18 (96). Insulation layer 32A may additionally be formed over capacitive plate 26A of capacitive element 24 or over the entire side of RFID tag 10. Additionally, insulation layer 32B is formed over capacitive plate 26B of capacitive element 24 (98). Insulation layer 32B may be formed over a larger portion of the second side of substrate 14 such that it covers more than just capacitive plate 26B.

First conductive shield 28A is positioned (e.g., as a discrete component or formed as a conductive layer) on a first side of substrate 14 (100). First conductive shield 28A is positioned to cover IC 18 and capacitive element 24. Additionally, conductive shield 28A may cover other components of RFID tag 10 that may be susceptible to damage from electrostatic discharge, such as the power source of an active RFID tag. Conductive shield 28A may, however, be positioned such that it does not cover a substantial portion of antenna 16. Moreover, conductive shield 28A should not electrically contact any portion of antenna 16.

Second conductive shield 28B is positioned (e.g., as a discrete component or formed as a conductive layer) on a second side of substrate 14 (102). Second conductive shield 28B is positioned to cover the portion of capacitive element 24 on the second side of the substrate, i.e., capacitive plate 26B. Second conductive shield 28B is positioned to be substantially opposite of first conductive shield 28A. First and second conductive shields 28 may be formed from metals, conductive polymers, ceramics, or the like. First and second conductive shields 28 may comprise, for example, pre-formed pieces of copper, silver, aluminum or other conductor that are positioned on RFID tag 10. Alternatively, first and second conductive shields 28 may be positioned by forming the shields at particular positions using conventional deposition or etching techniques.

One or more vias are formed through substrate 14 and insulation layers 32 (104). One or more conductors are positioned in the vias to electrically couple the first conductive shield 28A and second conductive shield 28B (106). The conductors may, for example, be copper posts fixing the first conductive shield to the second conductive shield. In this manner, a conductive cage 12 is formed to prevent damage to IC 18 and capacitive element 24 from electrostatic discharge.

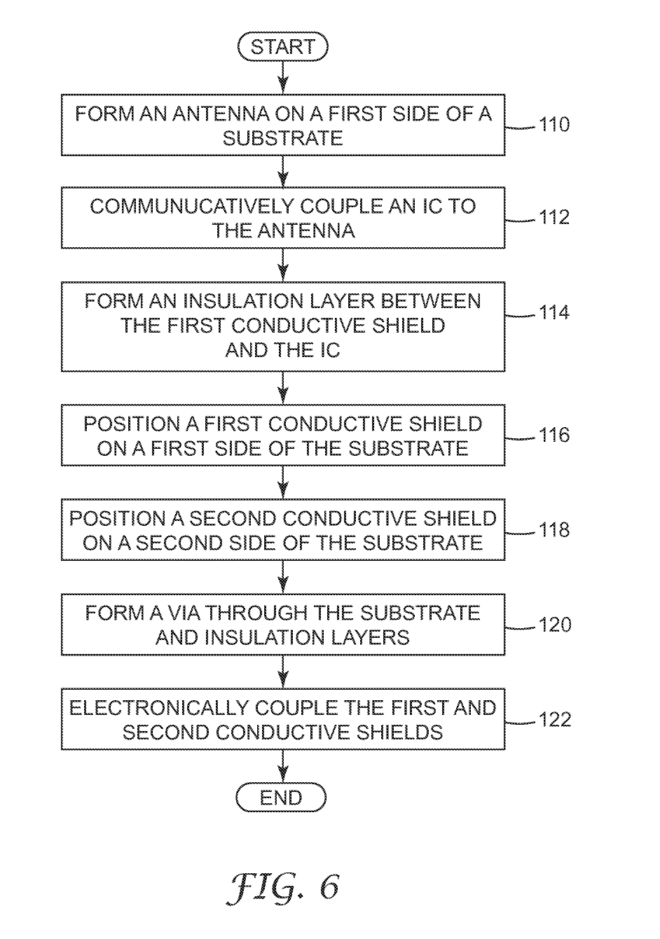

FIG. 6 is a flow diagram illustrating an exemplary method of forming an RFID tag, and is described in reference to RFID tag 50 of FIGS. 2A and 2B. Initially, antenna 54 is formed on a first side of substrate 52 (110). As described above, antenna 54 may be formed on substrate 52 by depositing or etching a conductive element in a particular pattern, such as a quarter-wavelength pattern illustrated in FIG. 2A. The conductive pattern may be formed via any number of deposition or etching techniques, such as vapor deposition, chemical etching and the like.

IC 56 is communicatively coupled to antenna 54 (112). IC 56 and antenna 54 may be formed on the same side of substrate 52 or on opposite sides of substrate 52. Insulation layer 62 is formed over IC 56 (114). Insulation layer 62 may additionally be formed over a larger portion of the side or over the entire side of RFID tag 50.

First conductive shield 60A is (e.g., as a discrete component or formed as a conductive layer) positioned on a first side of substrate 52 (116). First conductive shield 60A is positioned to cover IC 56. Additionally, conductive shield 60A may shield other susceptible components of RFID tag 50. Conductive shield 60A, however, may be positioned such that it does not cover a substantial portion of antenna 54, although it may cover smaller portions of antenna 54, such as loop 55. Moreover, conductive shield 60A should not electrically contact any portion of antenna 54.

Second conductive shield 60B is positioned (e.g., as a discrete component or formed as a conductive layer) on a second side of substrate 52 (118). Second conductive shield 60B is positioned to be substantially opposite of first conductive shield 60A. First and second conductive shields 60 may be formed from metals, conductive polymers, ceramics, or the like. First and second conductive shields 60 may comprise, for example, pre-formed pieces of copper, silver, aluminum or other conductor that are positioned on RFID tag 50. Alternatively, first and second conductive shields 60 may be positioned by forming the shields at particular locations on RFID tag 50 using conventional deposition or etching techniques.

One or more vias are formed through substrate 52 and insulation layer 62 (120). One or more conductors are positioned in the vias to electrically couple the first conductive shield 60A and second conductive shield 60B (122). The conductors may, for example, be copper posts fixing the first conductive shield to the second conductive shield. In this manner, a conductive cage 58 is formed to prevent damage to IC 56 from electrostatic discharge.

FIG. 7 is a graph of the results obtained during a first test in which conventional RFID tags and RFID tags having the described conductive cage were subjected to electrostatic discharge of varying voltages. The horizontal axis of the graph is the voltage of the electrostatic discharge applied to the particular RFID tag and the vertical axis is the normalized read range of the tag. The normalized read range of the tag is the read range of the tested tag after the electrostatic voltage is applied divided by the read range of the tag before the voltage is applied. As illustrated in the graph of FIG. 7, conventional RFID tags begin to fail at about 7-8 kV, while RFID tags with a conductive cage continue to function without any damage even after being exposed to over double the electrostatic voltage level (e.g., up to 20 kV).

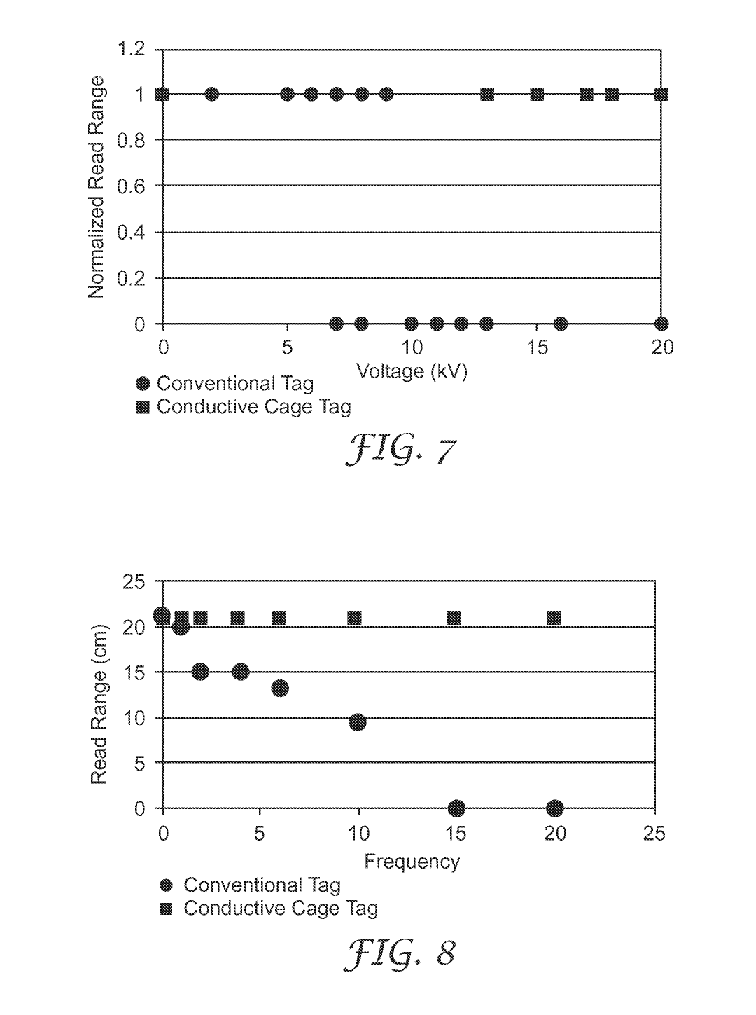

FIG. 8 is a graph of the results obtained during a test that subjected a conventional 13.56 MHz RFID tag and a 13.56 MHz RFID tag having the described conductive cage to several consecutive electrostatic discharges of a particular voltage level. In the example illustrated in FIG. 8, each of the RFID tags were exposed to a voltage level of 6 kV repeatedly. The horizontal axis of the graph is the number of times the tags were subject to the 6 kV discharge and the vertical axis is the read range in centimeters (cm) of the tag. As illustrated in the graph of FIG. 8, conventional RFID tags begin to have a reduced read range after application of only one or two 6 kV discharges, and have completely failed after being subjected to 15 or more consecutive 6 kV voltages. The conductive cage RFID tags described in this disclosure, however, continue to operate at a full read range even after being subjected to numerous 6 kV voltages.

The RFID tags described in this disclosure may comprise tags for a variety of different applications. The RFID tags may, for example, comprise electronic product code (EPC) tags, smart cards, electronic passports, and the like. Various embodiments have been described. These and other embodiments are within the scope of the following claims.

1. A radio frequency identification (RFID) tag comprising:
a substrate;
an antenna formed on a first side of the substrate;
an integrated circuit (IC) communicatively coupled to the antenna;
a first conductive shield positioned on a first side of the substrate to cover a top portion of the IC;
a second conductive shield positioned on a second side of the substrate; and
at least one conductor to electrically connect the first conductive shield and the second conductive shield through the substrate.

2. The RFID tag of claim 1, wherein the second conductive shield is located on the second side of the substrate substantially opposite from the first conductive shield located on the first side of the substrate to form a conductive cage that shields the IC from electrostatic discharge.

3. The RFID tag of claim 2, wherein the substrate includes at least one via to allow the conductor to pass through the substrate and electrically connect the first conductive shield and the second conductive shield.

4. The RFID tag of claim 3, wherein the conductive cage includes a plurality of conductors electrically coupling the first conductive shield and the second conductive shield.

5. The RFID tag of claim 1, further comprising an insulation layer formed between the first conductive shield and the IC.

6. The RFID tag of claim 1, further comprising a capacitive element formed on the substrate, wherein at least one of the first and second conductive shields cover the capacitive element and the IC.

7. The RFID tag of claim 6, wherein the capacitive element includes a first portion formed on the first side of the substrate and a second portion formed on the second side of the substrate, and further comprising an insulation layer between the second conductive shield and the second portion of the capacitive element.

8. The RFID tag of claim 1, wherein the first and second conductive shields shield the IC without shielding the antenna.

9. The RFID tag of claim 1, wherein the first conductive shield is integrated within the IC.

10. The RFID tag of claim 1, wherein the second conductive shield is integrated within the substrate.

11. The RFID tag of claim 1, wherein the RFID tag comprises one of a 125 kHz RFID tag, a 134 KHz RFID tag, a 13.56 MHz RFID tag, an 860-960 MHz RFID tag, and a 2.45 GHz RFID tag.

12. The RFID tag of claim 1, wherein the RFID tag comprises one of an electronic product code (EPC) tag, a smart card, and an electronic passport.

13. The RFID tag of claim 1, wherein the first and second conductive shields comprise metal conductive shields.

14. A method of manufacturing a radio frequency identification (RFID) tag comprising:
forming an antenna on a first side of a substrate;
communicatively coupling an integrated circuit (IC) to the antenna;
positioning a first conductive shield on a first side of the substrate to cover a top portion of the IC;
positioning a second conductive shield on a second side of the substrate; and
electrically coupling the first and second conductive shields through the substrate.

15. The method of claim 14, wherein positioning the first conductive shield and positioning the second conductive shield includes locating the second conductive shield on the second side of the substrate substantially opposite from the first conductive shield located on the first side of the substrate to form a conductive cage that shields the IC from electrostatic discharge.

16. The method of claim 14, further comprising forming an insulation layer between the first conductive shield and the IC.

17. The method of claim 14, further comprising forming a capacitive element on the substrate, wherein positioning the first and second conductive shields further comprises positioning the first and second conductive shields to cover the capacitive element.

18. The method of claim 17, wherein forming the capacitive element on the substrate comprises:
forming a first portion of the capacitive element on the first side of the substrate
forming a second portion of the capacitive element on the second side of the substrate;
forming an insulation layer between the second conductive shield and the second portion of the capacitive element.

19. The method of claim 14, wherein positioning the first and second conductive shields comprises positioning the first and second conductive shields to not substantially cover the antenna.

20. The method of claim 14, wherein electrically coupling the first and second conductive shields comprises forming a first via through the substrate to electrically couple the first and second conductive shields.
